(19) United States
(12) Patent Application Publication
(10) Pub. No.: US 2024/0288811 A1
(43) Pub. Date: Aug. 29, 2024

(54) IMAGE FORMING APPARATUS THAT ADJUSTS PRESSURE TO NIP REGION FROM PRESSURE ROLLER, BY SWITCHING BETWEEN NORMAL LEVEL AND LOW LEVEL LOWER THAN NORMAL LEVEL

(71) Applicant: KYOCERA Document Solutions Inc., Osaka (JP)

(72) Inventors: Shunsaku FUJII, Osaka (JP); Ryohei TOKUNAGA, Osaka (JP); Akihiro KONDO, Osaka (JP); Yuta KITABAYASHI, Osaka (JP); Rina KIKUGAWA, Osaka (JP); Hiroki KAWASAKI, Osaka (JP); Yuto MASAOKA, Osaka (JP)

(73) Assignee: KYOCERA Document Solutions Inc., Osaka (JP)

(21) Appl. No.: 18/589,060

(22) Filed: Feb. 27, 2024

(30) Foreign Application Priority Data
Feb. 28, 2023 (JP) 2023-029707

(51) Int. Cl. G03G 15/20

(52) U.S. Cl. CPC G03G 15/2064; G03G 15/205; G03G 15/2053; G03G 2215/2038

(57) ABSTRACT

An image forming apparatus includes an image forming device, a fixing device, and a controller. The fixing device includes a fixing belt, a heater, a pressure roller, a drive device, and a pressure adjustment mechanism that adjusts pressure to the nip region from the pressure roller, by switching between a normal level and a low level. When executing a print job, the controller causes the drive device to rotate the pressure roller, thereby causing the fixing belt to start to rotate, after causing the pressure adjustment mechanism to switch the pressure to the nip region to the low level, causes the pressure adjustment mechanism to switch the pressure to the nip region from the low level to the normal level, when a predetermined time has elapsed after the fixing belt started to rotate, and causes the image forming device to form an image according to the print job.

### INCORPORATION BY REFERENCE

This application claims priority to Japanese Patent Application No. 2023-029707 filed on Feb. 28, 2023, the entire contents of which are incorporated by reference herein.

### BACKGROUND

The present disclosure relates to a fixing device that fixes, by thermocompression, an image formed on a recording medium such as a recording sheet, and an image forming apparatus including the fixing device.

Existing image forming apparatuses that utilize the electrophotography process, such as a copier or a multifunction peripheral, include a fixing device that fixes the image formed on the recording medium. The fixing device includes a rotatable cylindrical fixing belt, a heater that heats the fixing belt, a heater retention member that holds the heater so as to bring the heater into contact with the inner circumferential surface of the fixing belt, and a pressure roller that holds the fixing belt between itself and the heater, and defines a nip region between itself and the fixing belt, through which the recording medium is transported in a nipped state, the pressure roller being configured to drive the fixing belt to rotate. With such a configuration, the image formed on the recording medium is fixed thereto, by being heated and pressed (thermocompression) in the nip region.

### SUMMARY

The disclosure proposes further improvement of the foregoing techniques.

In an aspect, the disclosure provides an image forming apparatus including an image forming device, a fixing device, and a control device. The image forming device forms an image on a recording medium. The fixing device includes a fixing belt, a heater, a pressure roller, a drive device, and a pressure adjustment mechanism. The fixing belt is formed in a cylindrical shape, and a circumferential surface thereof rotates in a circumferential direction. The heater heats the fixing belt from inside thereof. The pressure roller holds the fixing belt between the pressure roller and the heater, thereby defining a nip region, through which the recording medium having the image formed thereon by the image forming device is transported in a nipped state, between the pressure roller and the fixing belt, and causes, by rotating, the fixing belt to rotate. The drive device drives the pressure roller to rotate. The pressure adjustment mechanism adjusts pressure to the nip region from the pressure roller, by switching between a predetermined normal level and a predetermined low level lower than the normal level. The control device includes a processor, and acts as a controller that controls an operation of the heater and the pressure adjustment mechanism, when the processor executes a control program. When executing a print job, the controller causes the drive device to rotate the pressure roller, thereby causing the fixing belt to start to rotate, after causing the pressure adjustment mechanism to switch the pressure to the nip region to the low level, causes the pressure adjustment mechanism to switch the pressure to the nip region from the low level to the normal level, when a predetermined time has elapsed after the fixing belt started to rotate, and causes the image forming device to form an image according to the print job.

In another aspect, the disclosure provides an image forming apparatus including an image forming device, a fixing device, and a control device. The image forming device forms an image on a recording medium. The fixing device includes a fixing belt, a heater, a pressure roller, a drive device, and a pressure adjustment mechanism. The fixing belt is formed in a cylindrical shape, and a circumferential surface thereof rotates in a circumferential direction. The heater heats the fixing belt from inside thereof. The pressure roller holds the fixing belt between the pressure roller and the heater, thereby defining a nip region, through which the recording medium having the image formed thereon by the image forming device is transported in a nipped state, between the pressure roller and the fixing belt, and causes, by rotating, the fixing belt to rotate. The drive device drives the pressure roller to rotate. The pressure adjustment mechanism adjusts pressure to the nip region from the pressure roller, by switching between a predetermined normal level and a predetermined low level lower than the normal level. The control device includes a processor, and acts as a controller that controls an operation of the heater and the pressure adjustment mechanism, when the processor executes a control program. The controller sets a target temperature of the heater to a predetermined high temperature, higher than a normal temperature, after causing the pressure adjustment mechanism to switch the pressure to the nip region from the normal level to the low level.

### BRIEF DESCRIPTION OF THE DRAWINGS

FIG. 1 is a functional block diagram schematically showing an essential internal configuration of an image forming apparatus according to a first embodiment of the disclosure;

FIG. 2 is a perspective view showing an example of a fixing device included in the image forming apparatus;

FIG. 3 is a cross-sectional view schematically showing the example of the fixing device;

FIG. 4 is a partial perspective view showing a pressure adjustment mechanism of the fixing device and related parts, with nip pressure set to a normal level;

FIG. 5 is a side cross-sectional view showing the fixing device including the pressure adjustment mechanism, with the nip pressure set to the normal level;

FIG. 6 is a partial perspective view showing an end portion of the fixing device on the opposite side of the portion shown in FIG. 4 and FIG. 5, seen from an outer side;

FIG. 7 is a partial perspective view showing the pressure adjustment mechanism of the fixing device and related parts, with the nip pressure switched to a low level;

FIG. 8 is a side cross-sectional view showing the fixing device including the pressure adjustment mechanism, with the nip pressure switched to the low level;

FIG. 9 is a partial perspective view showing a cam position sensor of the fixing device and related parts, with the nip pressure set to the low level;

FIG. 10 is a flowchart showing an example of an operation performed by a control device of the image forming apparatus; and

FIG. 11 is a functional block diagram schematically showing an essential internal configuration of an image forming apparatus according to a second embodiment.

### DETAILED DESCRIPTION

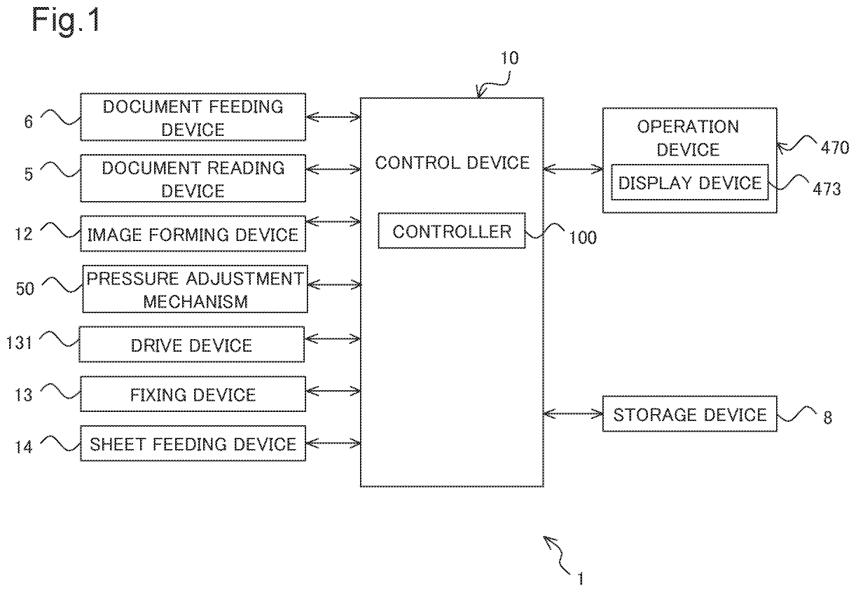

Hereafter, an image forming apparatus according to some embodiments of the disclosure will be described, with reference to the drawings. FIG. 1 is a functional block diagram schematically showing an essential internal configuration of the image forming apparatus according to a first embodiment of the disclosure. The image forming apparatus 1 is a multifunction peripheral having a plurality of functions, such as copying, printing, scanning, and facsimile transmission.

The image forming apparatus 1 includes a control device 10, a document feeding device 6, a document reading device 5, an image forming device 12, a fixing device 13, a sheet feeding device 14, an operation device 470, a pressure adjustment mechanism 50, a drive device 131, and a storage device 8.

The document feeding device 6 is openably connected to the upper face of the document reading device 5, for example via a hinge. The document feeding device 6 serves as a document retention cover, when the document reading device 5 reads a source document placed on the platen glass. The document feeding device 6 is configured as an automatic document feeder (ADF) including a document tray, and delivers the source documents placed thereon to the document reading device 5.

To perform the document reading operation, the image forming apparatus 1 operates as follows. The document reading device 5 optically reads the image on the source document delivered from the document feeding device 6 to the document reading device 5, or placed on the platen glass, and generates image data. The image data generated by the document reading device 5 is stored, for example, in an image memory.

To perform the image forming operation, the image forming apparatus 1 operates as follows. The image forming device 12 forms an image on a recording sheet, serving as a recording medium, and delivered from the paper feeding device 14, on the basis of the image data generated through the document reading operation, image data stored in the image memory, or image data received from a computer connected via the network.

The fixing device 13 heats and presses the recording sheet on which the toner image has been formed by the image forming device 12, to thereby fix the toner image on the sheet. The recording sheet that has undergone the fixing process is delivered to an output tray. The sheet feeding device 14 includes one or more sheet cassettes.

The drive device 131 includes a drive circuit serving as a drive source for rotating the pressure roller 30.

The operation device 470 includes various hard keys, and receives instructions to execute the functions and operations that the image forming apparatus 1 is configured to perform, according to inputs made by the user through the hard keys. The operation device 470 also includes a display device 473 for displaying, for example, an operation guide for the user. The operation device 470 receives, through a touch panel provided on the display device 473, the user's instruction based on an operation (touch operation) performed by the user on the operation screen displayed on the display device 473.

The display device 473 includes, for example, a liquid crystal display (LCD). The display device 473 includes the touch panel. When the user touches a button or a key displayed on the screen, the touch panel receives the instruction corresponding to the touched position.

The storage device 8 is a large-capacity storage device, such as a hard disk drive (HDD) or a solid state drive (SSD), and contains various control programs. The pressure adjustment mechanism 50 provides the pressing force from the pressure roller 30 to the fixing belt 20, and adjusts the pressure applied to a nip region N.

The control device 10 includes a processor, a random-access memory (RAM), a read-only memory (ROM), and an exclusive hardware circuit. The processor is, for example, a central processing unit (CPU), an application specific integrated circuit (ASIC), or a micro processing unit (MPU). The control device 10 includes the controller 100.

The control device 10 acts as the controller 100, when the processor operates according to the control program stored in the storage device 8. Here, the controller 100 may be constituted in the form of a hardware circuit, instead of being realized by the operation of the control device 10 according to the control program. This also applies to other embodiments, unless otherwise specifically noted.

The controller 100 serves to control the overall operation of the image forming apparatus 1. The controller 100 is connected to the document feeding device 6, the document reading device 5, the image forming device 12, the fixing device 13, the sheet feeding device 14, the operation device 470, the pressure adjustment mechanism 50, the drive device 131, and the storage device 8, and controls the operation of the mentioned components. For example, the controller 100 controls the operation of the image forming device 12 and the fixing device 13, to execute a print job.

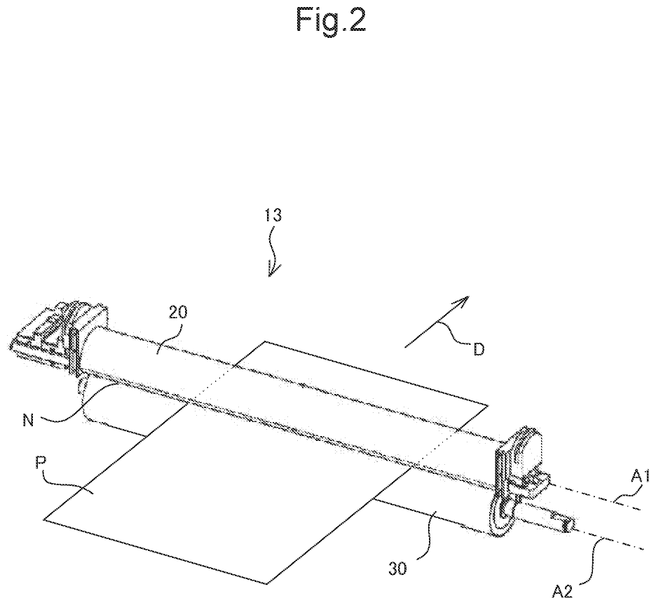

FIG. 2 is a perspective view showing an example of the fixing device 13 included in the image forming apparatus 1. The fixing device 13 includes a rotatable cylindrical fixing belt 20, and a pressure roller 30. The fixing belt 20 heats the recording medium (recording sheet P), having a toner image formed thereon. The fixing belt 20 is rotatable about an axial center defined as a first rotation axis A1, and extends in the direction of the first rotation axis A1.

The pressure roller 30 is rotatable about an axial center defined as a second rotation axis A2 parallel to the first rotation axis A1, and extends in the direction of the second rotation axis A2. The pressure roller 30 defines the nip region N, through which the recording sheet P is transported in a nipped state, between the pressure roller 30 and the fixing belt 20, and drives the fixing belt 20 to rotate. An arrow D in FIG. 2 indicates the transport direction of the recording sheet P.

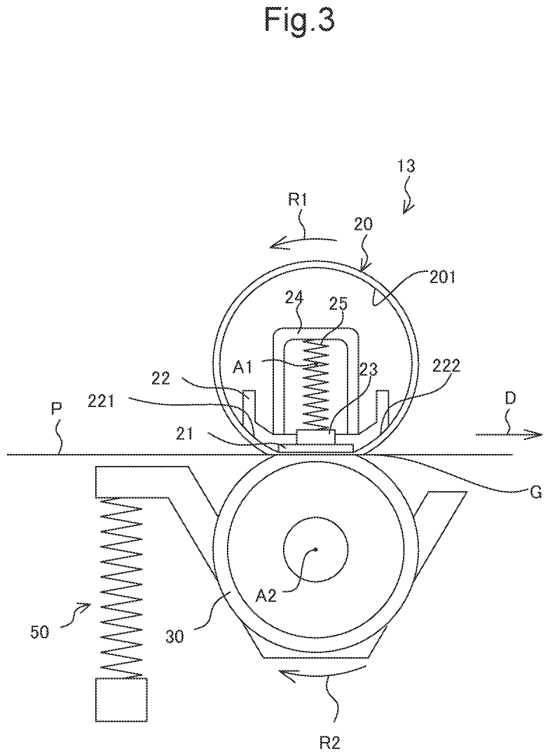

FIG. 3 is a cross-sectional view schematically showing an example of the fixing device 13. The fixing device 13 includes the fixing belt 20, the pressure roller 30, a heater 21, a heater retention member 22, a temperature sensor 23, a support member 24, a pressing member 25, and the pressure adjustment mechanism 50. In FIG. 3, the detailed structure of the pressure adjustment mechanism 50 is omitted.

The fixing belt 20 is driven to rotate in a first rotation direction R1 (counterclockwise in FIG. 3) about the first rotation axis A1, so as to follow up the rotation of the pressure roller 30 in a second rotation direction R2 (clockwise in FIG. 3) about the second rotation axis A2.

The heater 21 heats the fixing belt 20. The heater 21 is a plane heater extending in the first rotation axis A1, and located inside of the fixing belt 20 so as to oppose an inner circumferential surface 201 of the fixing belt 20. The heater 21 may be, for example, a ceramic heater including a ceramic substrate and a resistive heating element.

The heater retention member 22 retains the heater 21. The heater retention member 22 is formed of a heat-resistant resin material, in a shape having a U-shaped cross-section and extending in the direction of the first rotation axis A1. The heater retention member 22 includes opposing faces 221 and 222, respectively located on the upstream side and the downstream side in the transport direction D of the recording sheet P, and opposed to the inner circumferential surface 201 of the fixing belt 20.

The temperature sensor 23 is opposed to the heater 21, and detects the temperature of the heater 21. The temperature sensor 23 is inserted in a through hole formed in the heater retention member 22, so as to be abutted against the heater 21. The temperature sensor 23 is unfixed to the heater retention member 22. For example, a thermistor may be employed as the temperature sensor 23.

The support member 24 is a metal stay having an inverted U-shaped cross-section, and extending in the direction of the first rotation axis A1. The support member 24 is fixed to the main body housing of the fixing device 13. The heater retention member 22 is attached to the main body housing, so as to move toward and away from the support member 24. The support member 24 supports the posture of the heater retention member 22, when the end portion of the support member 24 on the side of the heater retention member 22 is in contact with the heater retention member 22.

The pressing member 25 is located between the temperature sensor 23 and the support member 24, and presses the temperature sensor 23 against the heater 21. The pressing member 25 may be, for example, a coil spring. Here, the mentioned configuration is merely exemplary, and the disclosure is not limited to such configuration.

The pressure adjustment mechanism 50 provides the pressing force from the pressure roller 30 to the fixing belt 20, and adjusts the pressure G applied to the nip region N. The pressure adjustment mechanism 50 is configured to switch the pressure G to two levels, namely between a predetermined normal level and a predetermined low level, lower than the normal level.

The pressure G (pressing force from the pressure roller 30 to the fixing belt 20) applied to the nip region N in the low level, by the pressure adjustment mechanism 50, is set to a value higher than or equal to the biasing force of the pressure roller 25. This is because, when the pressure G to the nip region N is smaller than the biasing force of the pressure roller 25, the force for supporting the heater 21 from below in FIG. 3 becomes insufficient, and the heater 21 may pop out from the heater retention member 22, which leads to failure in properly defining the nip region N. In this embodiment, it is unlikely that the heater 21 pops out from the heater retention member 22, and therefore there is no need to fix the heater 21 to the heater retention member 22, which keeps the structure of the device from being complicated. In this embodiment, the heater 21 is retained by the heater retention member 22, but not fixed thereto. Accordingly, the heater 21 can freely move toward the pressure roller 30, with respect to the heater retention member 22.

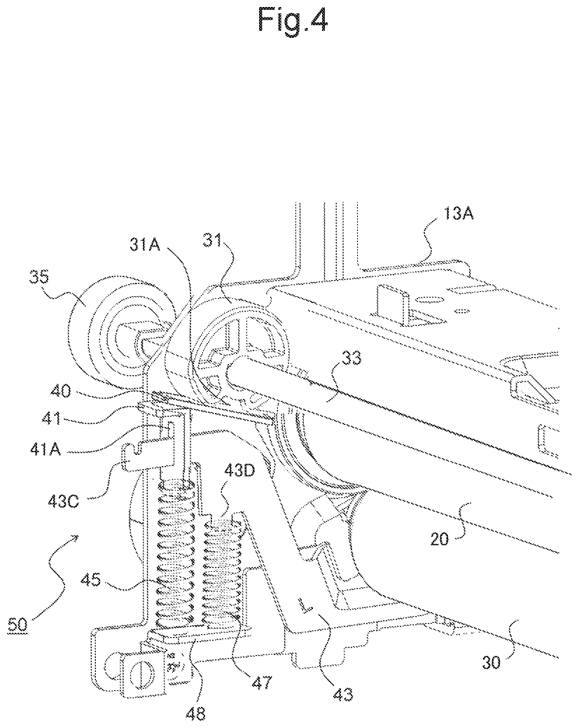

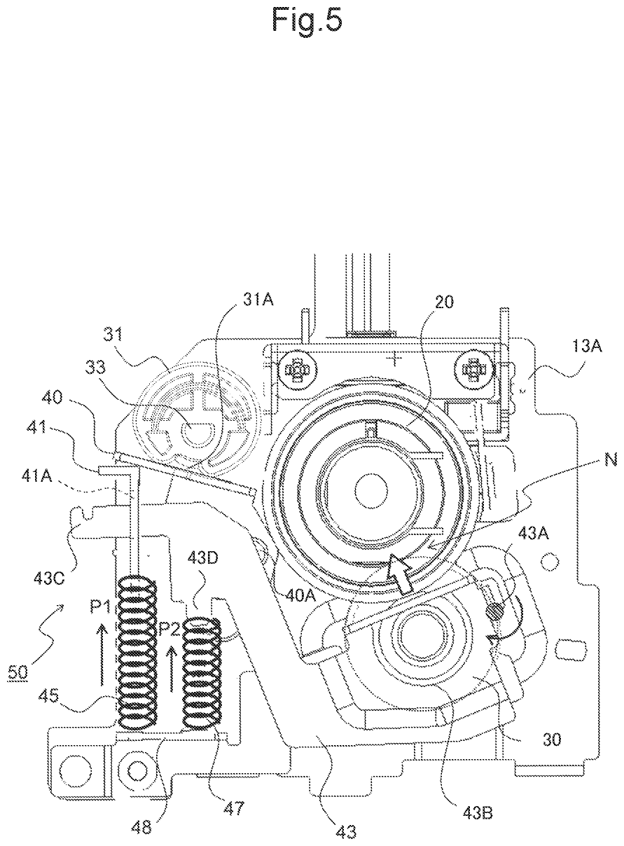

Hereunder, the configuration of the pressure adjustment mechanism 50 will be described. FIG. 4 is a perspective view showing the pressure adjustment mechanism 50 and the related parts. FIG. 5 is a side cross-sectional view showing the fixing device including the pressure adjustment mechanism 50. The pressure adjustment mechanism 50 includes an eccentric cam 31, a first pressure cancelling member 40, a second pressure cancelling member 41, an arm member 43, a first elastic member 45, and a second elastic member 47. The first pressure cancelling member 40, the second pressure cancelling member 41, and the arm member 43 are each formed by folding a sheet metal, such as iron, into a predetermined shape.

The eccentric cam 31, constituting a part of the pressure adjustment mechanism 50, is provided at each of the end portions of the fixing device 13 in the longitudinal direction. The two eccentric cams 31 are connected via a cam shaft 33, and a drive input gear 35 is fixed to an end portion of the cam shaft 33. The drive input gear 35 is connected to a drive output gear of a fixing pressure adjustment motor, via a gear train. For example, a stepping motor, the rotation direction and the rotation angle of which can be accurately controlled, may be employed as the fixing pressure adjustment motor.

The first pressure cancelling member 40 is supported by a frame side plate 13A of the fixing device 13, so as to pivot about a fulcrum 40A. The eccentric cam 31 is in contact with the upper face of the first pressure cancelling member 40, and the upper end of the second pressure cancelling member 41 is in contact with the face of the first pressure cancelling member 40 opposite to the face in contact with the eccentric cam 31. The second pressure cancelling member 41 is formed in a reverse L-shape in a side view, and supported by the frame side plate 13A of the fixing device 13 so as to slide in the up-down direction, and includes a slit 41A formed in the vertical portion.

The arm member 43 is supported by the frame side plate 13A of the fixing device 13, so as to swing about a pivotal shaft 43A. A U-shaped bearing 43B that rotatably supports the rotary shaft of the pressure roller 30 is provided, at a generally central portion of the arm member 43.

At a distal end portion of the arm member 43 (left end in FIG. 5), a bent portion 43C is formed, which is loosely fitted in the slit 41A of the second pressure cancelling member 41. In addition, a spring abutment 43D, protruding downward in a tongue shape, is formed between the bearing 43B and the bent portion 43C.

The first elastic member 45 and the second elastic member 47 are each constituted of a coil spring. The end surface at the upper end of the first elastic member 45 is abutted against the lower end portion of the second pressure cancelling member 41, and the end surface at the lower end of the first elastic member 45 is abutted against a spring pedestal 48 of the frame side plate 13A. In the end surface at the upper end of the second elastic member 47, the spring abutment 43D of the arm member 43 is inserted, and the end surface at the lower end of the second elastic member 47 is abutted against the spring pedestal 48 of the frame side plate 13A.

FIG. 4 and FIG. 5 illustrate the pressure adjustment mechanism 50, in the state where the nip pressure is set to the normal level (normal pressure for fixing operation). In the case of the normal level, a minor-diameter portion 31A of the eccentric cam 31 is in contact with the first pressure cancelling member 40, and the second pressure cancelling member 41 is lifted up by a biasing force P1 of the first elastic member 45, so as to make contact with the first pressure cancelling member 40. Accordingly, the bent portion 43C of the arm member 43, loosely fitted in the slit 41A of the second pressure cancelling member 41, is also lifted upward.

As result, the arm member 43 swings clockwise in FIG. 5, about the pivotal shaft 43A, and therefore the pressure roller 30 supported by the bearing 43B is pressed toward the fixing belt 20 (direction indicated by a white arrow in FIG. 5). At this point, the second elastic member 47 is in its free length, and a biasing force P2 of the second elastic member 47 is not exerted to the arm member 43. Therefore, the nip pressure originating only from the biasing force P1 of the first elastic member 45 is applied to the fixing nip region N.

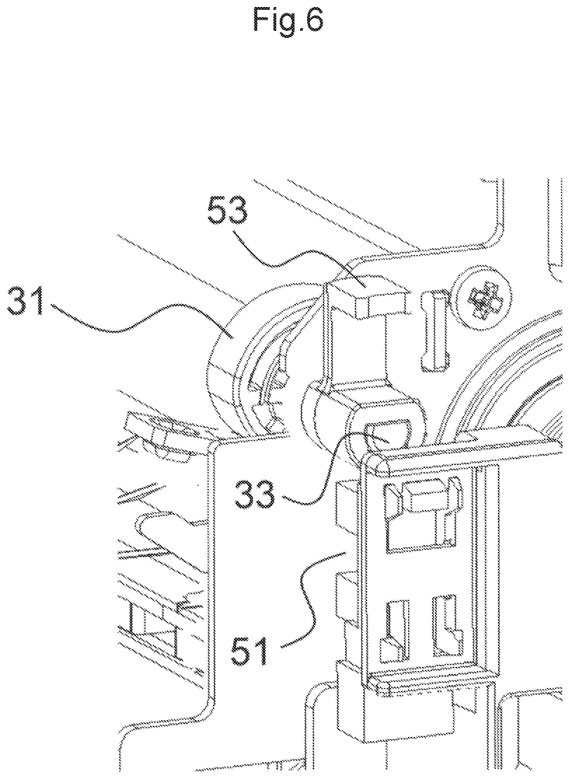

FIG. 6 is a partial perspective view showing the end portion of the fixing device 13 on the opposite side of the portion shown in FIG. 4 and FIG. 5, seen from the outer side. As shown in FIG. 6, a cam position sensor 51 that detects the phase of the eccentric cam 31 is provided on the outer side of the frame side plate 13A. The cam position sensor 51 is a P1 sensor including an optical sensor. In addition, a light blocking member 53 is fixed to the end portion of the cam shaft 33 protruding from the frame side plate 13A. When the nip pressure is at the normal level, the light blocking member 53 is located on the upper side of the cam shaft 33, and therefore the optical path for the optical sensor of the cam position sensor 51 is free from an obstacle.

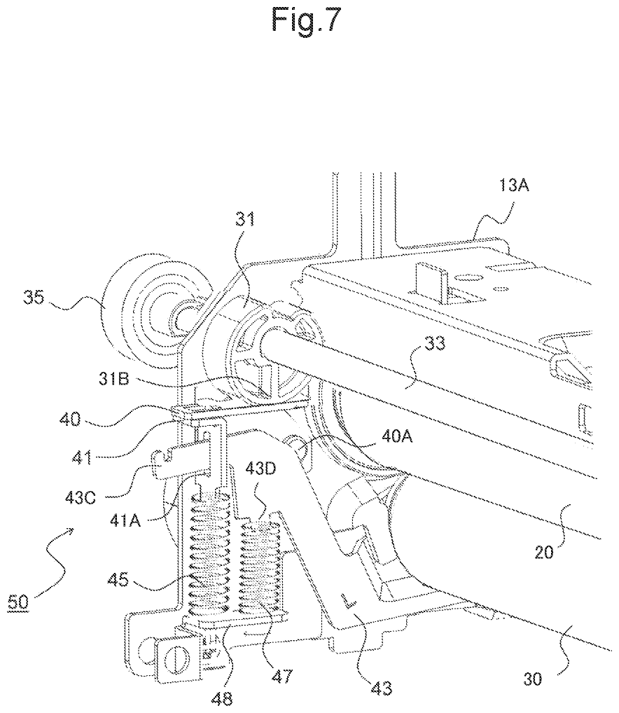

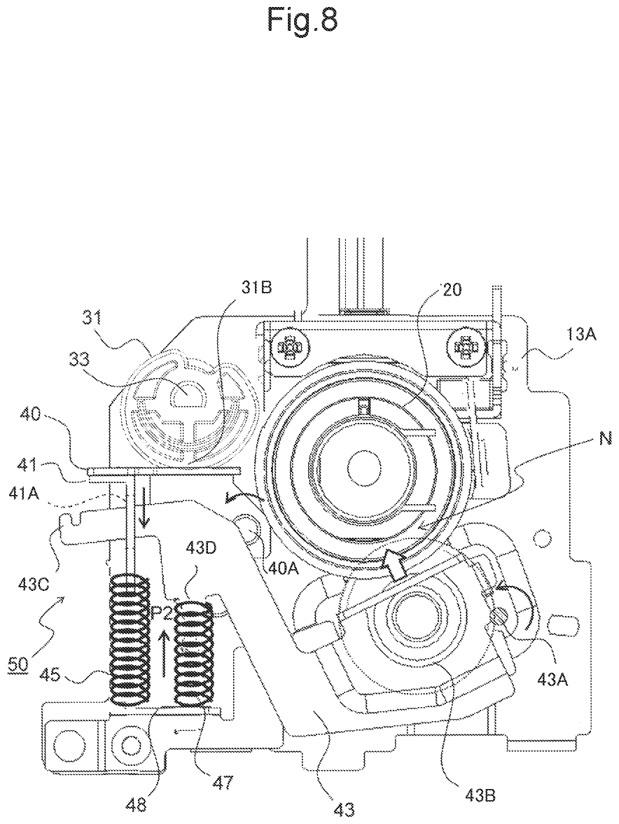

To switch the nip pressure to the low level, the fixing pressure adjustment motor is activated so as to rotate the eccentric cam 31 by 180° from the state of FIG. 4 and FIG. 5. Accordingly, a major-diameter portion 31B of the eccentric cam 31 makes contact with the first pressure cancelling member 40, thereby causing the first pressure cancelling member 40 to pivot counterclockwise, about the fulcrum 40A, as shown in FIG. 7 and FIG. 8. Owing to such pivotal movement of the first pressure cancelling member 40, the second pressure cancelling member 41 is pressed downward, so as to compress the first elastic member 45.

When the second pressure cancelling member 41 is pressed downward by a predetermined distance, the bent portion 43C of the arm member 43 is separated from the lower end of the slit 41A, and therefore the biasing force P1 of the first elastic member 45 is no longer exerted to the arm member 43. On the other hand, the biasing force P2 of the second elastic member 47, abutted against the spring abutment 43D, is exerted to the arm member 43, and therefore the nip pressure originating only from the biasing force P2 of the second elastic member 47 is applied to the fixing nip region N.

Here, the biasing force P2 of the second elastic member 47 is set to the force corresponding to the pressure of the low level, which is smaller than the biasing force P1 of the first elastic member 45 corresponding to the pressure of the normal level. In addition, even though the biasing forces P1 and P2 are the same as each other, the biasing force P2 of the second elastic member 47 is exerted at a position closer to the rotary shaft of the pressure roller 30, than the first elastic member 45, and therefore the force for lifting up the arm member 43 is reduced, compared with the state shown in FIG. 4 and FIG. 5. Thus, the arm member 43 swings counterclockwise from the state of the normal level by a predetermined amount, as shown in FIG. 8, and the nip pressure is set to the low level, lower than the normal level.

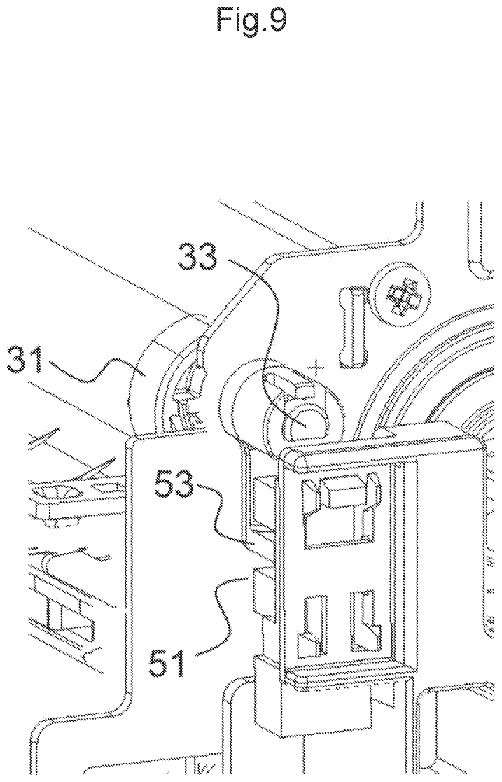

Further, when the nip pressure is switched to the low level, the light blocking member 53 also revolves by 180° together with the eccentric cam 31 and the cam shaft 33, as shown in FIG. 9, thereby being located on the lower side of the cam shaft 33, thus blocking the optical path for the optical sensor of the cam position sensor 51. In other words, the phase of the eccentric cam 31 can be detected, on the basis of the photodetection level of the cam position sensor 51.

The controller 100 controls the operation of the heater 21. When executing the print job, the controller 100 causes the drive device 131 to rotate the pressure roller 30 so as to cause the fixing belt 20 to start to rotate, after causing the pressure adjustment mechanism 50 to switch the pressure to the nip region N to the low level. Further, the controller 100 causes the pressure adjustment mechanism 50 to switch the pressure to the nip region N from the low level (hereinafter, low level LS) to the normal level (hereinafter, normal level NP), when a predetermined time has elapsed after the fixing belt 20 started to rotate, and causes the image forming device 12 to form an image according to the print job. The predetermined time refers to a time until the drive torque for driving the fixing belt 20 is lowered and stabilized at a certain level, after the fixing belt 20 started to rotate. Such time is determined in advance through experiments, and stored, for example, in a non-volatile memory provided in the control device 10.

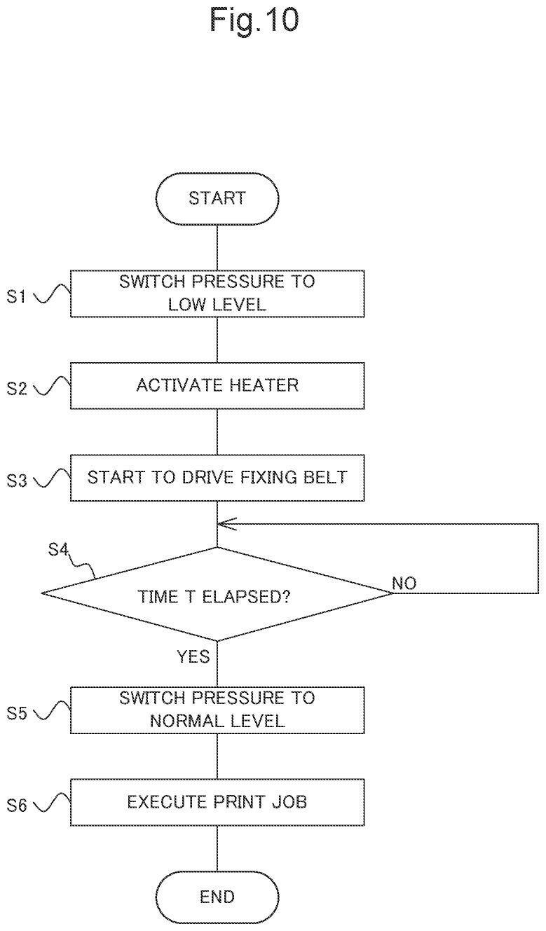

Referring now to a flowchart shown in FIG. 10, an exemplary pressure adjustment operation, performed by the image forming apparatus 1, will be described hereunder. This operation is performed when the operation device 470 receives a user's instruction to execute the print job.

The controller 100 causes the pressure adjustment mechanism 50 to switch the pressure to the nip region N to the low level LS, according to the instruction to execute the print job, received by the operation device 470 (S1). The controller 100 then activates the heater 21 (S2). Thereafter, the controller 100 causes the drive device 131 to rotate the pressure roller 30, thereby causing the fixing belt 20 to rotate so as to follow up the rotation of the pressure roller 30 (S3).

The controller 100 then decides whether the predetermined time T has elapsed, after the fixing belt 20 started to rotate (S4). Upon deciding that the time T has elapsed (YES at S4), the controller 100 controls the pressure adjustment mechanism 50 so as to switch the pressure to the nip region N from the low level LS to the normal level NP (S5), and controls the image forming device 12 and the fixing device 13, so as to execute the print job (S6). In this case, it suffices that the controller 100 causes the pressure adjustment mechanism 50 to switch from the low level LS to the normal level NP, before the recording sheet P, having the image formed thereon by the image forming device 12, comes close to the nip region N of the fixing device 13. At this point, the operation is finished.

Now, since the fixing belt defines the nip region in collaboration with the pressure roller as above, a larger drive torque is required to rotate the fixing belt, at the time that the rotation of the fixing belt is started. The increase in drive torque leads to an increase in load imposed on the mechanism for driving the fixing belt to rotate. Accordingly, a technique to suppress the increase in drive torque, by reducing the rotation speed of the fixing belt, has been developed. However, reducing the rotation speed of the fixing belt inevitably leads to degraded productivity.

The drive torque for rotating the fixing belt 20 becomes largest, at the time that the fixing belt 20 starts to rotate, and thereafter the drive torque is lowered and stabilized. In this embodiment, therefore, the pressure to the nip region N is switched to the low level LS at the time that the fixing belt 20 starts to rotate, and then switched from the low level LS to the normal level NP, when the time T elapses, and the recording sheet P having the image formed thereon is about to undergo the fixing operation.

When the pressure to the nip region N is set to the low level LS, the nip region N is narrowed, and therefore the drive torque for rotating the fixing belt 20 can be reduced, and the maximum value of the drive torque can be suppressed.

Further, the reduction in pressure to the nip region N may lead to degradation in fixing performance, and therefore some measures have to be taken, for example raising the target temperature of the fixing device 13, or reducing the printing speed. However, in this embodiment, it is only when the fixing belt 20 starts to rotate, that the pressure to the nip region N is set to the low level LS, and the pressure to the nip region N is switched to the normal level NP when the fixing operation is performed. Therefore, the fixing operation can be normally performed, without the need to depend on the mentioned measures. Thus, the arrangement according to this embodiment prevents an excessive increase in drive torque at the time that the fixing belt starts to rotate, without compromising the productivity.

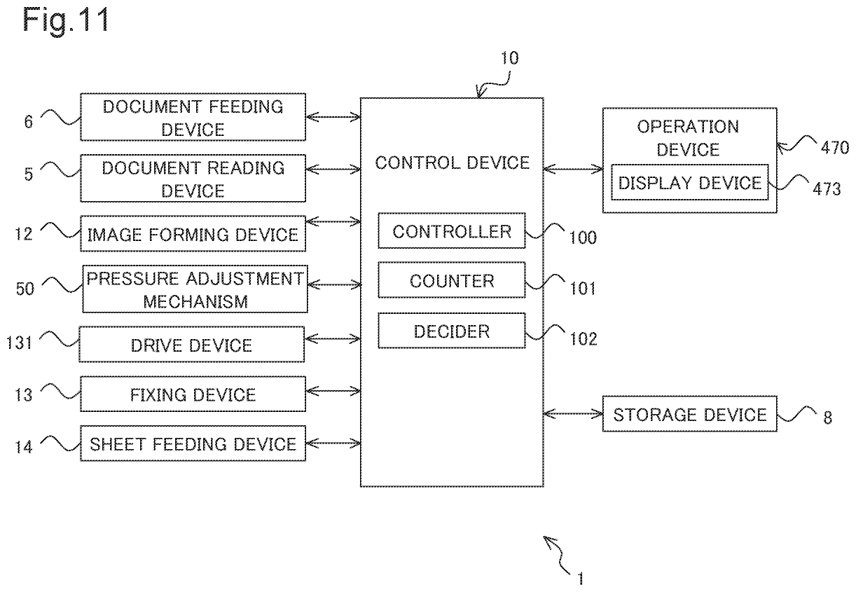

FIG. 11 is a functional block diagram schematically showing an essential internal configuration of an image forming apparatus according to a second embodiment. The image forming apparatus according to the second embodiment is different from the image forming apparatus shown in FIG. 1, in that the control device 10 further includes a counter 101 and a decider 102. The description of the same elements as those of the image forming apparatus shown in FIG. 1 will not be repeated.

The control device 10 further acts as the counter 101 and the decider 102, in addition to the controller 100, when the processor operates according to the control program stored in the storage device 8.

The counter 101 counts the number of sheets of the recording sheets P on which the image has been formed by the image forming device 12 (number of sheets printed).

The decider 102 decides whether a time for switching the pressure to the nip region N from the normal level NP to the low level LS has been reached, on the basis of the state of use of the image forming apparatus 1. For example, upon deciding that the number of sheets printed, counted by the counter 101, has reached a predetermined number of sheets, the decider 102 decides that the time for switching has been reached. When the image forming apparatus 1 is put to use for an extended period of time, the nip region N of the fixing device 13 may be widened, in which case the drive torque at the time that the fixing belt 20 starts to rotate may increase. Accordingly, the state of use of the image forming apparatus 1 can be utilized as an index for deciding whether the time for switching has been reached.

When the decider 102 decides that the time for switching has been reached, the controller 100 causes the pressure adjustment mechanism 50 to switch the pressure to the nip region N from the normal level NP to the low level LS, and sets the target temperature of the heater 21 to a predetermined high temperature (e.g., 220 degrees Celsius), higher than a normal temperature (e.g., 180 to 210 degrees Celsius). The temperature that enables the fixing operation to be normally performed, despite reducing the nip pressure as above, is detected through experiments carried out before the shipment of the products, and the temperature thus detected is stored in advance in the non-volatile memory provided in the control device 10, as the high temperature. With the arrangement according to the second embodiment, the pressure to the nip region N is switched from the normal level NP to the low level LS, about the time that the drive torque is increased, and therefore the excessive increase in drive torque can be effectively suppressed.

When the pressure to the nip region N is lowered, the fixing performance may be degraded, for example owing to decline in thermal conductivity from the fixing belt 20 to the recording medium. However, since the target temperature of the heater 21 is raised to the high temperature, higher than the normal temperature, and therefore the degradation in fixing performance due to the reduction of the pressure can be compensated, and the expected fixing performance can be maintained. As result, the arrangement according to the second embodiment also prevents the excessive increase in drive torque, without compromising the productivity.

According to the second embodiment, when the decider 102 decides that the time for switching has been reached, the controller 100 switches the pressure to the nip region N from the normal level NP to the low level LS, and also raises the target temperature of the heater 21 to the high temperature. Alternatively, as another embodiment, the pressure may be switched to the low level LS with the pressure adjustment mechanism 50, and the target temperature may be set to the high temperature (e.g., 220 degrees Celsius) in advance, before the shipment of the image forming apparatus 1 (i.e., before the image forming apparatus 1 is put to use).

The disclosure may be modified in various manners, without limitation to the foregoing embodiments. Further, the configurations and processings described in the foregoing embodiments with reference to FIG. 1 to FIG. 11 are merely exemplary, and in no way intended to limit the disclosure to those configurations and processings.

While the present disclosure has been described in detail with reference to the embodiments thereof, it would be apparent to those skilled in the art the various changes and modifications may be made therein within the scope defined by the appended claims.

What is claimed is:

1. An image forming apparatus comprising:
an image forming device that forms an image on a recording medium;
a fixing device including:
a fixing belt formed in a cylindrical shape, and a circumferential surface of which rotates in a circumferential direction;
a heater that heats the fixing belt from inside thereof;
a pressure roller that holds the fixing belt between the pressure roller and the heater, thereby defining a nip region, through which the recording medium having the image formed thereon by the image forming device is transported in a nipped state, between the pressure roller and the fixing belt, and causes, by rotating, the fixing belt to rotate;
a drive device that drives the pressure roller to rotate; and
a pressure adjustment mechanism that adjusts pressure to the nip region from the pressure roller, by switching between a predetermined normal level and a predetermined low level lower than the normal level; and
a control device including a processor, and configured to act, when the processor executes a control program, as a controller that controls an operation of the heater and the pressure adjustment mechanism,
wherein, when executing a print job, the controller causes the drive device to rotate the pressure roller, thereby causing the fixing belt to start to rotate, after causing the pressure adjustment mechanism to switch the pressure to the nip region to the low level, and
causes the pressure adjustment mechanism to switch the pressure to the nip region from the low level to the normal level, when a predetermined time has elapsed after the fixing belt started to rotate, and causes the image forming device to form an image according to the print job.

2. The image forming apparatus according to claim 1,
wherein the predetermined time is a time stored in advance, corresponding to a period until a drive torque for driving the fixing belt is lowered and stabilized, after the fixing belt starts to rotate.

3. The image forming apparatus according to claim 1,
wherein the fixing device further includes:
a heater retention member that retains the heater inside of the fixing belt;
a temperature sensor that detects a temperature of the heater, by contacting the heater from an opposite side of the pressure roller; and
a pressing member that presses the temperature sensor toward the heater, and
the pressure of the low level is set to a value larger than or equal to a pressing force of the pressing member.

4. The image forming apparatus according to claim 3,
wherein the temperature sensor is unfixed to the heater retention member.

5. An image forming apparatus comprising:
an image forming device that forms an image on a recording medium;
a fixing device including:
a fixing belt formed in a cylindrical shape, and a circumferential surface of which rotates in a circumferential direction;
a heater that heats the fixing belt from inside thereof;
a pressure roller that holds the fixing belt between the pressure roller and the heater, thereby defining a nip region, through which the recording medium having the image formed thereon by the image forming device is transported in a nipped state, between the pressure roller and the fixing belt, and causes, by rotating, the fixing belt to rotate;
a drive device that drives the pressure roller to rotate; and
a pressure adjustment mechanism that adjusts pressure to the nip region from the pressure roller, by switching between a predetermined normal level and a predetermined low level lower than the normal level; and
a control device including a processor, and configured to act, when the processor executes a control program, as a controller that controls an operation of the heater and the pressure adjustment mechanism,
wherein the controller sets a target temperature of the heater to a predetermined high temperature, higher than a normal temperature, after causing the pressure adjustment mechanism to switch the pressure to the nip region from the normal level to the low level.

6. The image forming apparatus according to claim 5,
wherein the control device further acts as a decider that decides whether a time for switching the pressure from the normal level to the low level has been reached, on a basis of a state of use of the image forming apparatus, and
the controller causes the pressure adjustment mechanism to switch the pressure to the nip region from the normal level to the low level, when the decider decides that the time for switching has been reached.

7. The image forming apparatus according to claim 6,
wherein the decider decides that the time for switching has been reached, when a total number of sheets that have been printed reaches a predetermined number of sheets.

8. The image forming apparatus according to claim 5,
wherein the fixing device further includes:
a heater retention member that retains the heater inside of the fixing belt;
a temperature sensor that detects a temperature of the heater, by contacting the heater from an opposite side of the pressure roller; and
a pressing member that presses the temperature sensor toward the heater, and
wherein the pressure of the low level is set to a value larger than or equal to a pressing force of the pressing member.
